(19) United States
(12) Patent Application Publication
(10) Pub. No.: US 2014/0119864 A1
(43) Pub. Date: May 1, 2014

(54) Portable Vehicle Lift and Repair System

(71) Applicant: Jacob E. Kiragu, Palm Beach, FL (US)

(72) Inventor: Jacob E. Kiragu, Palm Beach, FL (US)

(21) Appl. No.: 13/664,114

(22) Filed: Oct. 30, 2012

(51) Int. Cl. B60P 1/43

(52) U.S. Cl. CPC B60P 1/43
USPC 414/538; 414/537

(57) ABSTRACT

A vehicle lift and repair system includes a flatbed trailer provided with a wood-like or separate metallic surface upon a base of the trailer, the surface having recesses, and weight bearing axles beneath in a region of the recesses. Included is a hydraulic lift having a base support positioned within the recesses in the surface of the trailer, the recesses having a depth sufficient to include all components of the lift, including a top thereof substantially flush with the surface when the lift is retracted. The lift is preferably positioned in relation to a transverse mid-line between the weight-bearing axles. Ramps facilitate positioning on the lift of an auto-to-be-repaired. A generator, compressor and hydraulic fluid reservoir for the hydraulic vehicle lift are situated toward a front of the trailer.

### BACKGROUND OF THE INVENTION

A need has existed are for a system which would facilitate the servicing of vehicles and certain heavy machinery at locations remote from the normal service area of such vehicle or other equipment.

In a civilian context, such a system would be of considerable convenience to the owner of a car or other vehicle where it is either inconvenient to leave the vehicle at a car service station or who does not have the time to function without his vehicle other than an absolute minimum of time required for a particular repair. A similar need has long existed for the accessing of vehicles, whether disabled or otherwise, in remote locations in cases in which it would be more practical for a mobile lift and repair system of the type described herein to simply travel to the site of the vehicle and perform the necessary repairs at that location. In such a system, various specific mechanical and electrical components and machinery of many types would be consolidated within a single mobile platform, and typically towed by a truck, for use in repairs, service and maintenance of vehicles or machinery at a desired location.

In a military application, return of a vehicle in need of repairs to the motor pool location of a particular unit often is not practical, whereas a mobile repair system of the type disclosed herein would represent a far more practical approach. The same would be the case in remote but non-combat areas such as border patrol operations.

To the knowledge of the inventor, prior art relevant to the invention as set forth herein does not exist.

### SUMMARY OF THE INVENTION

The present portable vehicle lift and repair system includes a flatbed trailer provided with a wood-like or separate metallic surface upon a base of the trailer, the surface having linear orthonormal recesses therein, the trailer having at least two weight bearing axles and associated hubs end tires situated beneath in a region of said orthonormal recesses. The system also includes a mid-rise normally portable hydraulic vehicle lift having a base support thereof positioned within at least a subset of said recesses in the wood-like surface of the trailer, the recesses having a depth sufficient to include all components of the lift, including a top thereof substantially flush with the surface of the trailer, said lift positioned in general relation to a transverse mid-line on said trailer between said weight-bearing axles. Further included are ramps to facilitate positioning of an auto-to-be-repaired, the ramps located against a rear edge of the trailer, and of sufficient length to reduce a grade of a vehicle to be driven or pulled up said ramps than eight degrees or less. Also included in the system is a generator, compressor and hydraulic fluid reservoir for the hydraulic vehicle lift, all situated forwardly of the lift proximally to a front of the trailer. Also provided are retaining tanks for dirty oil removed from a vehicle or machinery to be serviced.

It is accordingly an object of the invention to provide a mobile vehicle and equipment service and repair platform which may be towed or otherwise transported to a vehicle, equipment or the like in need of repairs in which elevation of the vehicle or equipment to effectively accomplish the necessary repairs is an essential aspect thereof.

It is another object to provide a portable vehicle lift and repair system of the above type which may service a disabled vehicle, through the use of winch to pull the vehicle onto the hydraulic lift of the system, and therefrom accomplish the repair of the vehicle at or near the location of its disablement.

It is a yet further object of the invention to provide a system of the above type in which the hydraulic lift thereof is fully retractable to the surface level of the flatbed employed in the system.

It is a further object to provide a concept by which all parties involved in the repair, maintenance or inspection of vehicles will be able to perform the same in a cost-effective fashion, providing remote services at the location of the customer, wherever that location may be.

The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 is a side perspective schematic view of the present portable lift and repair system.

FIG. 2 is a top plan view illustrating the linear othornormal recesses provided within the surface of the inventive system.

FIG. 3 is a cross-sectional view taken through Line 3-3 of FIG. 2 when the scissors lift is retracted.

FIG. 4 is a view, generally similar to that of FIG. 1, however showing the manner in which an awning may be provided to the present system for the protection of the work area from elements to which the area may be exposed.

FIG. 5 is an enlarged side view of a representative hydraulic scissors lift shown in FIGS. 1 and 4.

FIG. 6 is a top view of the scissors lift of FIG. 5, however showing the manner in which the rear ramps may be folded downwardly and into a covered area of the flat bed when the use of an awning is not necessary.

FIG. 7 is an enlarged perspective view of the hydraulic lift of a portion of FIG. 4 with a vehicle positioned thereon.

### DETAILED DESCRIPTION OF THE INVENTION

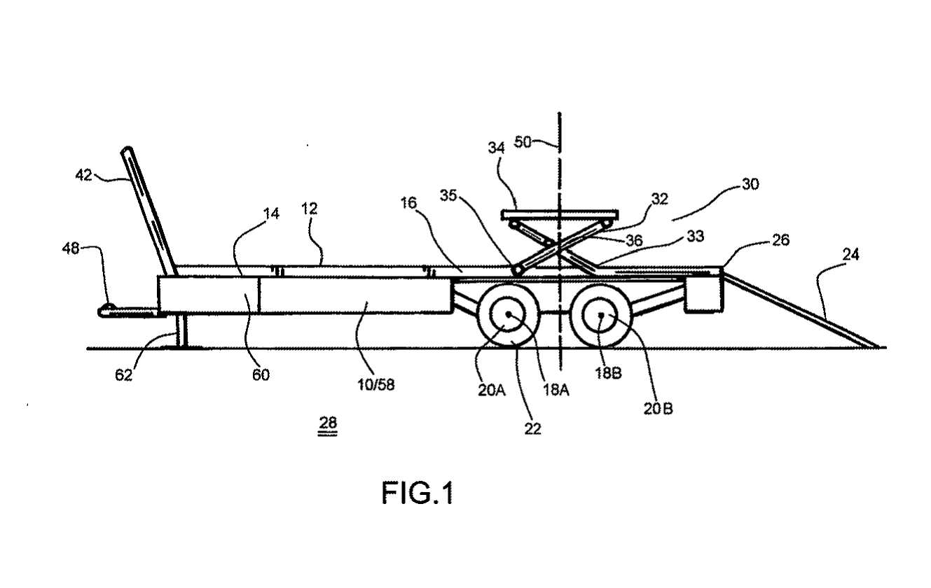

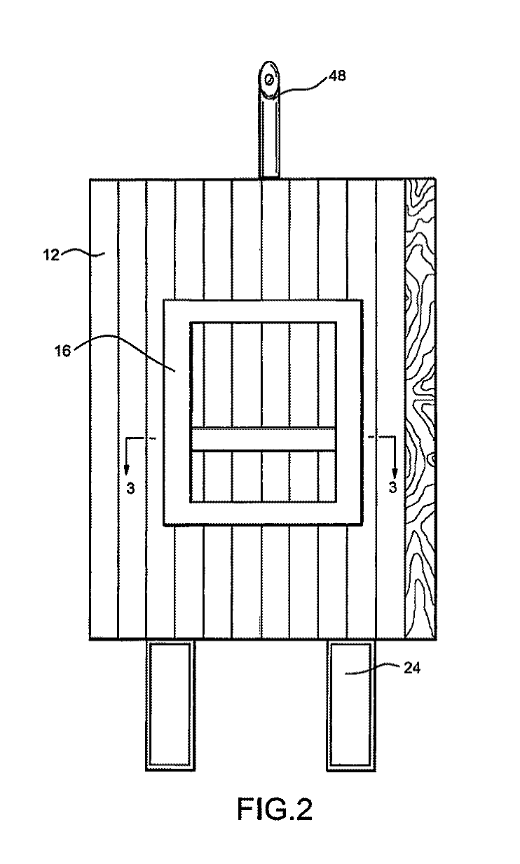

With reference to FIG. 1, there is shown a portable vehicle lift and repair system, in accordance with the present invention, which includes a flat bed trailer 10 which is provided with a wood, wood-like, or separate metallic surface 12 upon a substrate 14 of the trailer. As may be noted in FIG. 2, said wood surface 12 is provided with a pattern of linear orthonormal recesses 16 therein, the function of which is more fully described below.

As may be further noted with reference to FIG. 1, trailer 10 is typically, but not in all cases, provided with at least two weight bearing axles 18A and 18B and hubs 20A and 20B, upon which are mounted tires 22. That is, a single axle which may be employed.

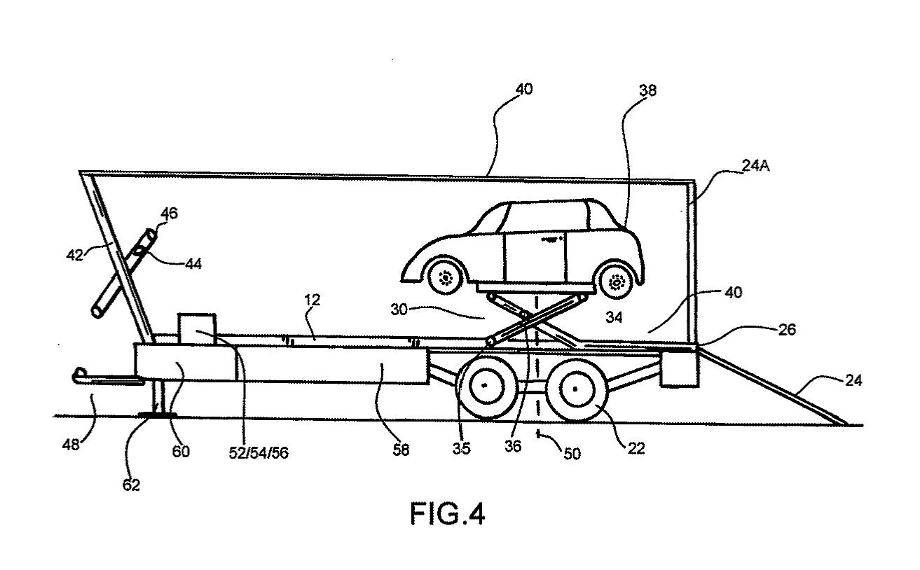

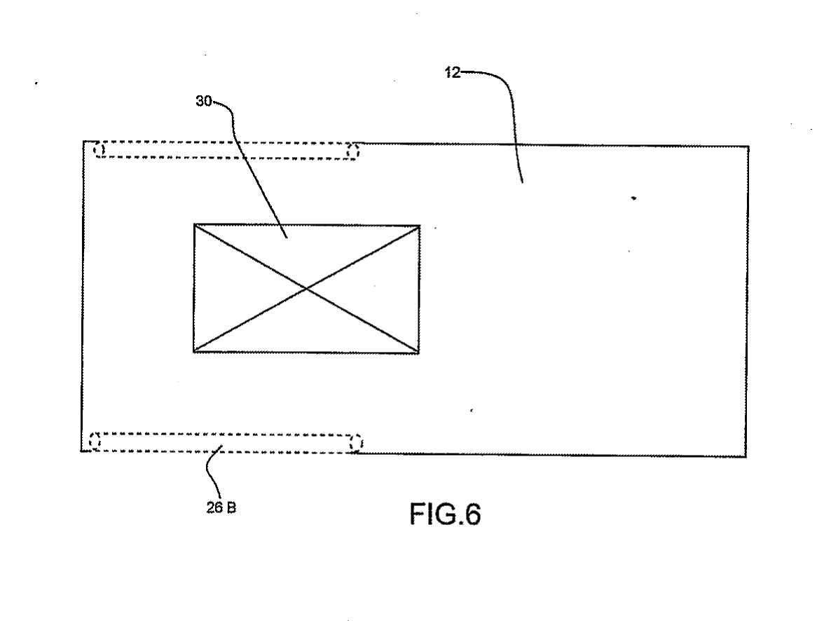

The flatbed trailer also includes ramps 24 which facilitate positioning of an auto-to-be-repaired onto the flatbed. The ramps are located against a rear edge 26 of the trailer 10 in a manner, such as a hinge connection, which enables their rotation upwardly relative to the ground 28 or the surface upon which the trailer is located. See FIGS. 4 and 6. Further, it is essential that said ramps 24 define a length sufficient to reduce the grade of a vehicle to be driven or pulled-up upon said ramps to eight degrees or less.

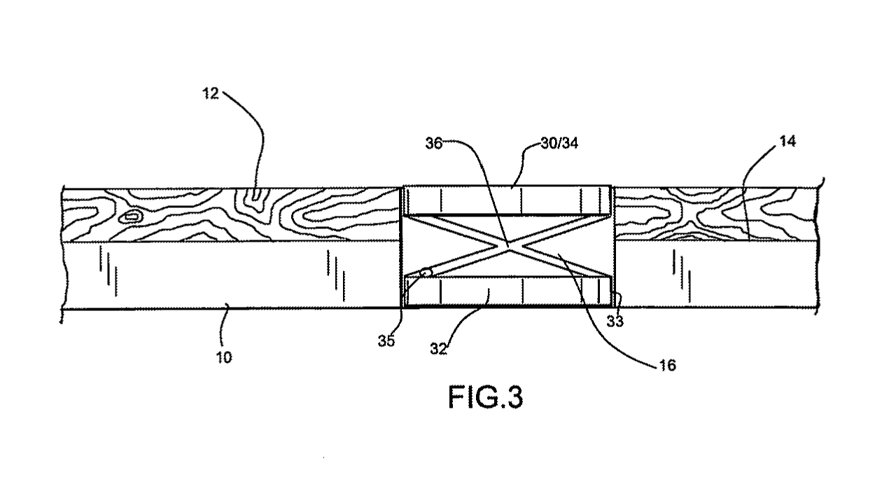

Toward the rear of the system shown in FIG. 1 is provided a midrise portable hydraulic lift 30 which includes a scissors portion 32 as well as its own ramp or base 34. When in retraced state, the hydraulic lift is contained within orthonormal recesses 16 in the manner shown in FIG. 3. In other words, the flatbed trailer appears ordinary in appearance when the hydraulic lift is retracted and the trailer is in tow.

In FIG. 4 are shown additional features of the system which include a car 38 positioned upon lift ramp 34 after it has been driven onto the flatbed firstly along, firstly, ramp 24, and thereafter ramp 40 which connects the up ramp to lift ramp 34 (when in retracted position) of the vehicle lift 30. It is noted that because the hinge at the rear edge of the trailer is swivel-like in character, ramp 24 may be rotated upward into position 24A (see FIG. 4) so that, in such orientation, ramp 24 may also serve as a support for an awning 42 which, in combination with a front support 42, provides an adequate support for an awning or tent-like structure 40 so that the lift and vehicles as well as the mechanics performing work or service on the vehicle may be at least partially protected from the elements of external environment.

Further shown in FIG. 4 is winch 44 which, together with its cable 46, may be employed to lift or tow an immobile vehicle up ramps 24 and 40 and onto top ramp 34 of the vehicle lift. A suitable such winch 44 would be an 8000 pound Silverback Series Electric Recovery winch, operating at 55 HP at a 265:1 gear reduction and having an 80 ft cable at about 8 mm diameter. The figures also show a hitch 48 which enables the connection any vehicle that may be used to haul the system. It is also noted that the center of gravity 36 of the lift 30 is preferably positioned at a midpoint 50 between the trailer tires 22 to afford maximum stability of the hydraulic vehicle lift and elevated vehicle relative to the trailer.

Proximally to a forward area of the trailer is provided a generator 52, compressor 54, and hydraulic fluid reservoir 56 which are shown conceptually in FIG. 4 but more particularly as to location in FIG. 9 (more fully discussed below).

Beneath the surface of the flatbed are provided tanks 58 and 60 for use in the retention of dirty oil respectively taken from the vehicle 38 being serviced. It is to be understood that the size and arrangements of these tanks may be varied and, in a given application, may be positioned entirely above the surface 12 of flatbed trailer, as well as below.

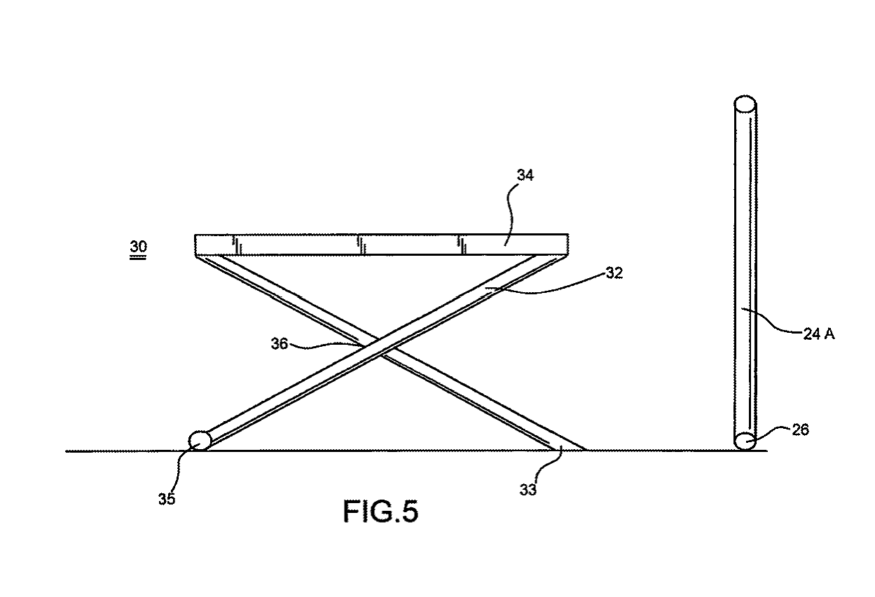

FIG. 5 is an enlarged side view of the portable hydraulic vehicle lift 30 including its ramp 34, support arms 32 and center of gravity 36. Also shown in FIG. 5 is a vertical elevation 24A of ramp 24.

In FIG. 6 the hydraulic lift is shown fully retracted, in a similar fashion to that of FIG. 3, however also showing is ramp 24 in its fully forward position 24B which represents its storage location beneath the flat bed trailer when it is in transport.

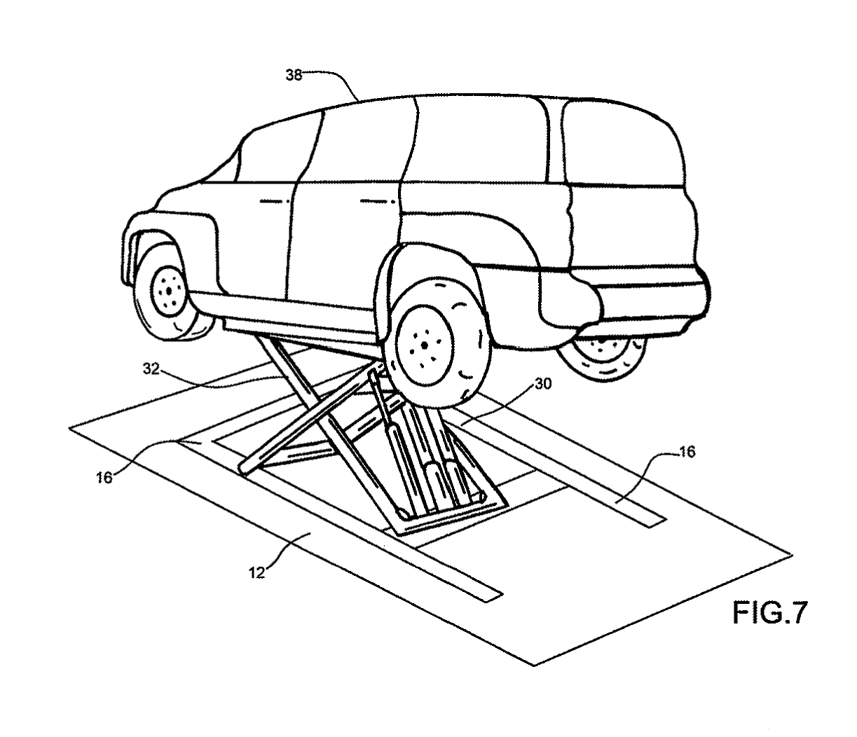

FIG. 7 is a more detailed view of the vehicle lift and orthonormal recesses 16 structure of the trailer flatbed.

It is to be appreciated that tool storage bins may be provided either above or below the surface of the flatbed.

In summary, the present invention defines an electrically powered hydraulic lift using AC or DC motors, mounted upon a mobile platform in a strategic fashion for the lifting of vehicles of any utility equipment on wheels or bearings, this including heavy machinery. The scope of this invention therefore includes a lift of any type mounted upon a trailer or the like which can be towed thereon, or driven on by its own power, and to gain access to the undercarriage of motor vehicles or other machinery on wheels or bearings. The inventive system, as such, allows the maintenance, replacement, inspection systems or parts of a vehicle which require lifting to access such parts. The present system, as above set forth (see Background of the Invention above) allows a service technician to visit the customer, as opposed to the technicians being at a fixed site, this having obvious benefits and convenience to many. Such convenience and, as applicable, necessity will exist where the vehicle to be serviced is situated in a remote area, e.g., the U.S.-Mexican border, and remote areas of military operation where a given vehicle is not in suitable proximity to a motor pool or the like.

The positioning of the lifting mechanism and particularly its center of gravity over the midpoint of the wheels of the mobile platform together with flatbed-stabilizing struts provide in special degree of stability to the inventive system.

The above set forth winch also enables immobile vehicles to be pulled onto the hydraulic lift of the system such that the vehicles which are disabled and/or at remote locations may be serviced.

As above noted, there are additionally provided stability struts 62 to provide stability to any part of the platform but, commonly, toward the front thereof. The system will preferably include generator 52 to serve as a power supply for power tools and an air compressor 54 for air tools and to provide suitable wheel pressure to the tires 22 of the system. The batteries, in lieu of or in addition to said generator, may be included to power the hydraulics of the system.

Hydraulic reservoir 56 (see FIG. 9) ensures recirculation of hydraulic fluid for the lifting mechanism and a hydraulic power pack (not shown) provides the lifting necessary for the operation of the lift.

Many types of retractable sun/rain/awnings are applicable to the instant system.

As may be appreciated, storage spaces of unlimited variety for items inclusive of straps, tools and spare tires may be provided.

Should the user wish, a power tool such as a bench press or pulley may be readily added to the wood surface of the flat bed trailer as may unlimited variety of power tools.

Typically, the present system will include a first aid compartment as well as a GPS tracking device for security as well as anti-theft purposes.

In terms of sequence of operation, the following would be typical:

1. A vehicle or piece of machinery is driven-up upon the platform or winched and thereupon if it is immobile.

2. Hydraulic stability struts are released to enable stability of the flatbed particularly during elevation of heavy machinery requiring service.

3. The vehicle or machinery is then lifted to its area of elevation or to another part of the flatbed if elevation is not a necessary part of the intended service.

4. After repairs are completed, the vehicle or machinery is lowered and taken off the platform, typically through the use of ramps as above described.

5. Through the above, service persons involved in repairs, maintenance and/or inspection will be able to perform concise, efficient and convenient on-site services at a location of the customer's choosing.

All working components, including service components, can be efficiently mounted upon various parts of the platform.

A typical specification for a suitable flatbed is as follows:
Category: Flatbed—gooseneck (this might also be a tow hitch for smaller vehicles in the future)
   Make: b&b
   Model: fb8x30gn
   Trailer Number: b1

A variety of trailers/manufacturers are suited for the present system. Typical specifications are:
Size: 8′6″×25′ (+5′)
10,000# axles/electric brakes
3 pieces extended-a-bed/48″ axle spread
16″ radial tires/front tool box
Treated wood floor/modular wire harness
Rear drop legs/l.e.d lights
Rub rail with stake pockets primer paint
20,000# GVWR/dual jacks, single speed

Typical specifications for a suitable hydraulic lift are:
MD-6 P 6000 lbs. capacity midrise frame lift
Lifting capacity: 6,000 lbs./2,724 kg
Max lifting height without adapters: 48″/1,219 mm
Lowered height: 4¾″/121 mm
Lifting time: 45 sec
Motor: A suitable AC or DC power supply
Shipping weight: 852 lbs./387 kg
Shipping dimensions: 84″×41″×27″/2,134 mm×1,041 mm×686 mm

It is noted that stability struts are frequently provided as a part of the trailer itself.

In respect to the generator to be used, a suitable generator would be that of an 8500 watt portable, Pentagon used for emergencies in RVs drawing 70 amperes in operation and usable at 110 or 220 volts. Such a unit can power the hydraulic lift system as above set forth and provide outlets for tools and other additional equipment. Such a generator can handle all tools and equipment needed for the system.

With respect to air compressor, a compress suitable the specifications would include for air supply to tools, wheels and the like (California air tools 1675a ultra quiet & oil-Free ¾ hp 1.6 gal. aluminum tank air compressor. 5.5 amps/600 watts). One may use another model as there are many choices.

It is noted that hydraulics reservoir operates to circulate hydraulic fluid for the lifting mechanism and is linked to a hydraulic motor. It is noted that hydraulic specifications would include a power pack for various control command prompts IBT-115, preferably a single-port Power Pack made by Wren Tools.
Current: 20 amps.
Power 1⅛ horsepower
Speed: 12,000 rpm
Maximum oil flow: 704 in³ @ 100 psi
Oil reservoir: 2.5 gallon
Overall dimensions: 17.14″×9.5″×18.12″
Complete with 4″ 10,000 psi gauge
Weight: 58 pounds (without oil)

A power pack, as above referenced, may provide various control commands, for example, said AIB-115. Such a power pack for the lifting mechanism enables use of high torque tools, typically working with the reservoir.

Other parameters of the system are as follows:
Dirty oil retaining tank—for dirty oil. Safe-t-tank corporation brands seem most suitable. They are available from 50 gl. to 1500 gl.
Storage space compartments—

Delta JOBOX 1405980 Aluminum Tool Drawer Storage System.
26″L×36″W×6″H 3-Drawer System.

A suitable unit is 3 drawers wide and 1 drawer high.

Heavy-gauge aluminum construction is durable enough to stand up to heavy loads.

Heavy-duty drawer glides support up to 75 lbs. per drawer.

Drawer latches automatically lock the drawers when closed.

Pins prevent the storage drawer from rolling off the glides.

Removable dividers allow you to customize and keep tools, supplies or parts organized. Each drawer has 5 slots for dividers (15 total) and the unit comes with 6 dividers.

Bench/press/pulley—

WDS 6559 Mandrel Presses brand.

Long leverage plus gearing for maximum power. Heat treated, machine cut gears.

Work can be pressed off a mandrel without removing the carrier.

Ideal for inserting or extracting bushes or bearings.

A tubular guard is fitted on the top surface of the casting for operator safety and protection of the ram.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A portable vehicle lift and repair system, comprising:
(a) a flatbed trailer provided with a wood-like or separate metallic surface upon a base of said trailer, said surface having linear orthonormal recesses therein, said trailer having at least two weight bearing axles and associated hubs and tires situated beneath in a region of said orthonormal recesses;
(b) a mid-rise normally portable hydraulic vehicle lift having a base support thereof positioned within at least a subset of said recesses in said wood-like surface of said trailer, said recesses having a depth sufficient to include all components of said lift, including a top thereof substantially flush with said surface of said trailer, said lift positioned in general relation to a transverse mid-line on said trailer between said weight-bearing axles;
(c) ramps to facilitate positioning of an auto-to-be-repaired, said ramps located against a rear edge of said trailer, said ramps of sufficient length to reduce a grade of a vehicle to be driven or pulled up said ramps to eight degrees or less;
d) a generator, compressor and hydraulic fluid reservoir for said hydraulic vehicle lift, all situated forwardly of said hydraulic lift proximally to a front of said flatbed trailer; and
(e) retaining tanks for dirty oil taken from a vehicle to be serviced.

2. The system as recited in claim 1, in which said vehicle lift comprises:
an hydraulic lift having one end of its base fixed and an opposite and selectable securable at a desired position.

3. The system as recited in claim 1, in which a connecting end of each of said ramps comprises:
means for a rotatable securement to a back end of said flatbed trailer selectable rotatable onto a substantially vertical orientation to define a rear support for a trailer awning;

4. The system as recited in claim 3, further comprising:
at least one rigid member rotationally secured proximally to a front of said trailer, said member selectably rotatable into a substantially vertical orientation to define a front support for said trailer awing.

5. The system as recited in claim 2, further comprising:
tool-storage bins secured upon or beneath said trailer.

6. The system as recited in claim 2, further comprising:
stabilizing struts extensible from said trailer to a ground or surface upon which said trailer is parked.

7. The system as recited in claim 2, further comprising:
a winch for pulling immobile vehicles on to and up said ramps.

8. The system as recited in claim 7, in which a flatbed connecting end of each of said ramps comprises:
means for rotatable securement to a back end of said flatbed trailer selectable rotatable onto a substantially vertical orientation to define a rear support for a trailer awning.

9. The system as recited in claim 8, further comprises:
at least one rigid member rotationally secured proximally to a front of said trailer, said member selectably rotatable into a substantially vertical orientation to define a front support for a trailer awning.

10. The system as recited in claim 8, in which said flatbed connecting end of said ramps further comprises means for enabling a forward rotation of each ramp, past a vertical position and against said surface of the flatbed.

11. A portable vehicle lift and repair system, comprising:
(a) a flatbed trailer provided with a wood-like or separate metallic surface upon a base of said trailer, said surface having linear orthonormal recesses therein, said trailer having one weight bearing axle, an associated hub and tires situated beneath in a region of said orthonormal recesses;
(b) a mid-rise normally portable hydraulic vehicle lift having a base support thereof positioned within at least a subset of said recesses in said wood-like surface of said trailer, said recesses having a depth sufficient to include all components of said lift, including a top thereof substantially flush with said surface of said trailer, said lift positioned in general relation to a transverse mid-line on said trailer over said weight-bearing axle;
(c) ramps to facilitate positioning of an auto-to-be-repaired, said ramps located against a rear edge of said trailer, said ramps of sufficient length to reduce a grade of a vehicle to be driven or pulled up said ramps to eight degrees or less;
d) a generator, compressor and hydraulic fluid reservoir for said hydraulic vehicle lift, all situated forwardly of said hydraulic lift proximally to a front of said flatbed trailer; and
(e) retaining tanks for dirty oil taken from a vehicle to be serviced.

12. The system as recited in claim 11, in which said vehicle lift comprises:
an hydraulic lift having one end of its base fixed and an opposite and selectable securable at a desired position.

13. The system as recited in claim 12, in which a connecting end of each of said ramps comprises:
means for a rotatable securement to a back end of said flatbed trailer selectable rotatable onto a substantially vertical orientation to define a rear support for a trailer awning;

14. The system as recited in claim 13, further comprising:
at least one rigid member rotationally secured proximally to a front of said trailer, said member selectably rotatable into a substantially vertical orientation to define a front support for said trailer awing.

15. The system as recited in claim 12, further comprising:
tool-storage bins secured upon or beneath said trailer.

16. The system as recited in claim 12, further comprising:
stabilizing struts extensible from said trailer to a ground or surface upon which said trailer is parked.

17. The system as recited in claim 12, further comprising:
a winch for pulling immobile vehicles on to and up said ramps.

18. The system as recited in claim 17, in which a flatbed connecting end of each of said ramps comprises:
means for rotatable securement to a back end of said flatbed trailer selectable rotatable onto a substantially vertical orientation to define a rear support for a trailer awning.

19. The system as recited in claim 17, in which said flatbed connecting end of said ramps further comprises means for enabling a forward rotation of each ramp, past a vertical position and against said surface of the flatbed.
